(19) United States
(12) Patent Application Publication
(10) Pub. No.: US 2011/0140883 A1
(43) Pub. Date: Jun. 16, 2011

(54) COMMUNICATION APPARATUS AND POSITIONAL INFORMATION COMMUNICATING METHOD

(75) Inventor: Makoto YAMASHITA, Tokyo (JP)

(73) Assignee: Kabushiki Kaisha Toshiba, Tokyo (JP)

(21) Appl. No.: 12/898,263

(22) Filed: Oct. 5, 2010

(30) Foreign Application Priority Data
Dec. 10, 2009 (JP) 2009-280932

(51) Int. Cl. G08B 1/08

(52) U.S. Cl. 340/539.13

(57) ABSTRACT

A communication apparatus includes: a transmitter configured to transmit to an external apparatus a search signal for requesting the external apparatus to transmit an address that is uniquely assigned to the external apparatus; a receiver configured to receive a response signal being transmitted from the external apparatus in response to the search signal, the response signal containing positional information and the address of the external apparatus; and an extractor configured to extract the positional information from the response signal received by the receiver.

### CROSS-REFERENCE TO THE RELATED APPLICATION(S)

The present application is based upon and claims priority from prior Japanese Patent Application No. 2009-280932, filed on Dec. 10, 2009, the entire contents of which are incorporated herein by reference.

### BACKGROUND

1. Field

This embodiment relates to a communication apparatus and a positional information communicating method.

2. Description of the Related Art

Techniques of acquiring current positional information using a GPS position determining system or the like are known. To utilize such a technique, it is necessary to prepare a module having a position determining function. However, an apparatus incorporating such a module may become heavier, larger in size, and more expensive. A technique is therefore desired that enables acquisition of current positional information even in an apparatus that is not equipped with a module having a position determining function.

In these circumstances, techniques are available which detect a current position by acquiring position data from a communication apparatus having a GPS position determining function or the like. In a conventional system, a portable terminal receives position data from a communication apparatus having a GPS position detecting section or the like by a narrow-band communication and sends the received position data to a center.

However, in acquiring positional information by communicating with an apparatus having a position determining function, a communication destination may be set in advance, before establishment of communication connection. Furthermore, communication connection processing takes long time. As a result, positional information may not be acquired easily.

### BRIEF DESCRIPTION OF THE DRAWINGS

A general configuration that implements the various features of the present invention will be described with reference to the drawings. The drawings and the associated descriptions are provided to illustrate embodiments of the invention and not to limit the scope of the invention.

FIG. 1 shows an example usage of a communication system to which a first embodiment of the present invention is applied.

FIG. 2 shows the configuration of another communication system to which the first embodiment of the invention is applied.

FIG. 3 shows pieces of information contained in an EIR which is transmitted in the first embodiment of the invention.

FIG. 4 shows an information table which is generated in the first embodiment of the invention.

FIG. 5 shows a position selection screen which is displayed in the first embodiment of the invention.

FIG. 6 shows an operation sequence of a communication system which performs a conventional Bluetooth communication.

FIG. 7 shows an operation sequence of a communication system to which the first embodiment of the invention is applied.

FIG. 8 shows the procedure of an operation that a communication apparatus sends an EIR in the first embodiment of the invention.

FIG. 9 shows the procedure of an operation that a communication apparatus determines its position in the first embodiment of the invention.

FIG. 10 shows a positional information display screen which is displayed by the communication apparatus of FIG. 9 in the first embodiment of the invention.

FIG. 11 shows pieces of information contained in an EIR which is transmitted in a second embodiment of the invention.

FIG. 12 shows the procedure of an operation that a communication apparatus determines its position in the second embodiment of the invention.

### DETAILED DESCRIPTION

Embodiments according to the present invention will be described in detail with reference to the accompanying drawings. The scope of the claimed invention should not be limited to the examples illustrated in the drawings and those described in below.

### First Embodiment

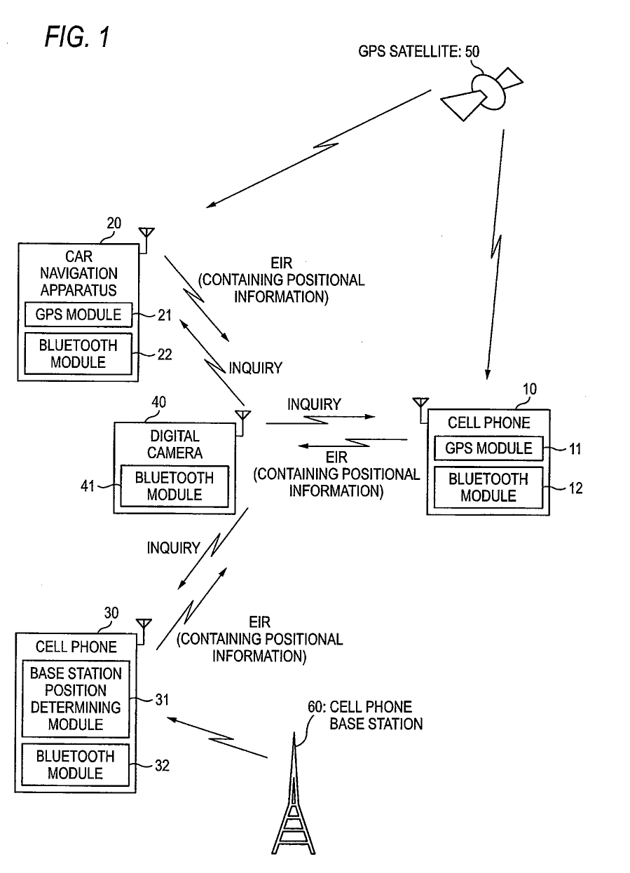

FIG. 1 schematically shows an example usage of a communication system to which a first embodiment is applied. This communication system is provided with a cell phone 10, a car navigation apparatus 20, a cell phone 30 and a digital camera 40.

Equipped with a GPS module 11 and a Bluetooth (registered trademark) module 12, the cell phone 10 is capable of acquiring current positional information when the GPS module 11 receives a signal from a GPS satellite 50. Equipped with a GPS module 21 and a Bluetooth module 22, the car navigation apparatus 20 is capable of acquiring current positional information using the GPS module 21 like the cell phone 10 can. In the cell phone 30 which is quipped with a base station position determining module 31 and a Bluetooth module 32, the base station position determining module 31 is capable of acquiring positional information of a closest cell phone base station 60 from the cell phone base station 60.

The digital camera 40 is equipped with a Bluetooth module 41, however, is not provided with a dedicated module for determining its own position.

This embodiment allows an apparatus having no dedicated position determining module such as the digital camera 40 to acquire positional information from, for example, an apparatus having a position determining module such as the cell phone 10, the car navigation apparatus 20, or the cell phone 30.

In this communication system, the digital camera 40 sends, to unspecified apparatus inquiry signal (signal “Inquiry”), which is a search signal used in Bluetooth communication. Inquiry signal is to request an apparatus that has received the inquiry signal to send back a response signal containing its own Bluetooth address. The Bluetooth address is a unique address that is assigned to each Bluetooth module.

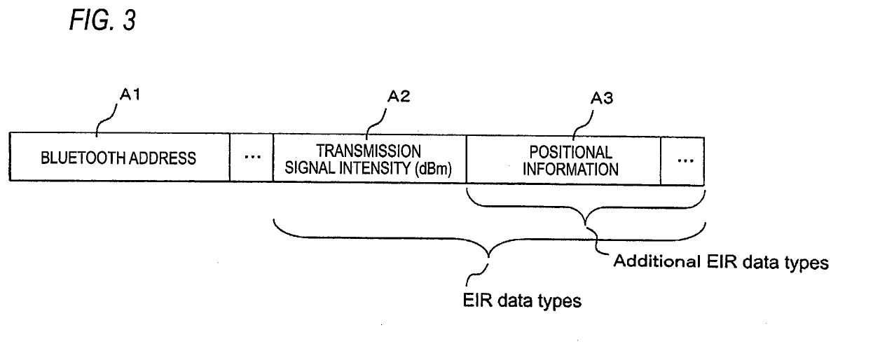

When receiving inquiry signal from the digital camera 40, each of the cell phone 10, the car navigation apparatus 20, and the cell phone 30 sends, to the digital camera 40, an EIR (extended inquiry response) which is a response signal containing positional information. The digital camera 10 receives the EIRs and extracts pieces of positional information contained in the respective EIRs. In this manner, the digital camera 10 can easily acquire pieces of positional information without the need for establishing communication connections to unspecified apparatus. The EIR will be described later with reference to FIG. 3.

Bluetooth modules are incorporated in various apparatus. For example, there are cell phones and car navigation apparatus that are equipped with a Bluetooth module to send audio data to a hands-free headset or the like. Furthermore, there are such electronic apparatus as digital cameras that are equipped with a Bluetooth module to enable data exchange with a PC or the like.

That is, the embodiment not only makes it possible to easily acquire pieces of positional information from unspecified apparatus by receiving response signals containing the respective pieces of positional information but also enables using existing communication modules such as Bluetooth modules.

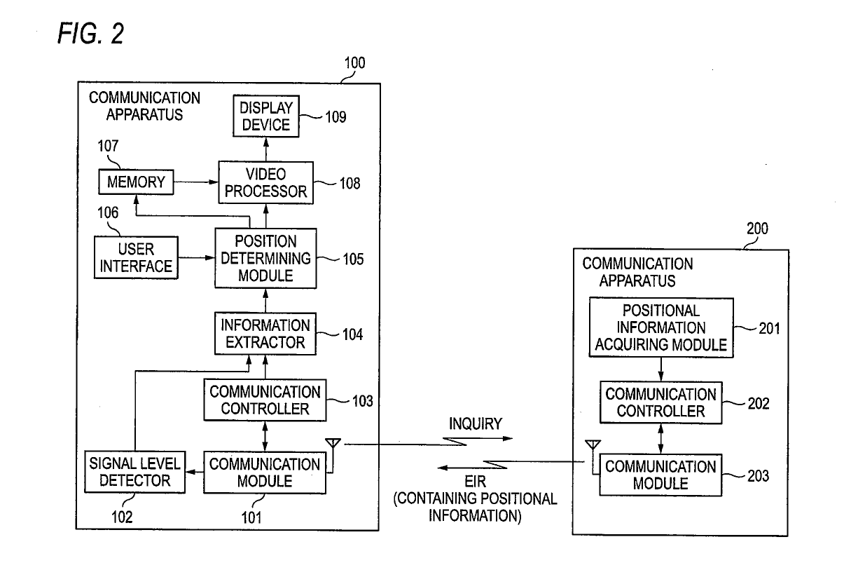

Next, another communication system to which the embodiment is applied will be described with reference to FIG. 2. This communication system is provided with a communication apparatus 100 and a communication apparatus 200, each of which can perform a wireless communication according to the Bluetooth standard. The communication apparatus 100 is equipped with a communication module 101, a signal level detector 102, a communication controller 103, an information extractor 104, a position determining module 105, an user interface 106, a memory 107, a video processor 108, and a display device 109. Examples of the communication apparatus 100 are a cell phone, a digital camera, and a PC, each of which is not provided with a dedicated position determining module.

The communication module 101 sends and receives a signal to and from an external communication apparatus. When receiving an inquiry signal transmission command from the communication controller 103, the communication module 101 sends, to unspecified communication apparatus, inquiry signal for requesting sending-back of a Bluetooth address. When receiving an EIR containing positional information from the communication apparatus 200 or the like, the communication module 101 supplies the received EIR to the communication controller 103. After receiving the EIR, the communication module 101 establishes a communication connection to the external apparatus having the Bluetooth address contained in the received EIR by sending a connection request signal to the external apparatus (i.e., to the received Bluetooth address).

When the communication module 101 receives an EIR, the signal level detector 102 detects reception signal level of the EIR and supplies information indicating the detected reception signal level to the information extractor 104.

The communication controller 103 generates inquiry signal and supplies it to the communication module 101, and supplies an inquiry signal transmission command to the communication module 101. The communication controller 103 may perform generation of inquiry signal and output of an inquiry signal transmission command either automatically at regular time intervals or in response to a certain manipulation of the user.

The communication controller 103 supplies the information extractor 104 with an EIR that is received from the communication module 101. The communication controller 103 determines whether or not a prescribed time T (sec) has elapsed from the transmission of inquiry signal by the communication module 101. The prescribed time T is a preset timeout period of EIR reception processing. When the prescribed time T has elapsed from the transmission of inquiry signal, the communication controller 103 supplies the information extractor 104 with a notice to that effect and causes timeout of the EIR reception processing.

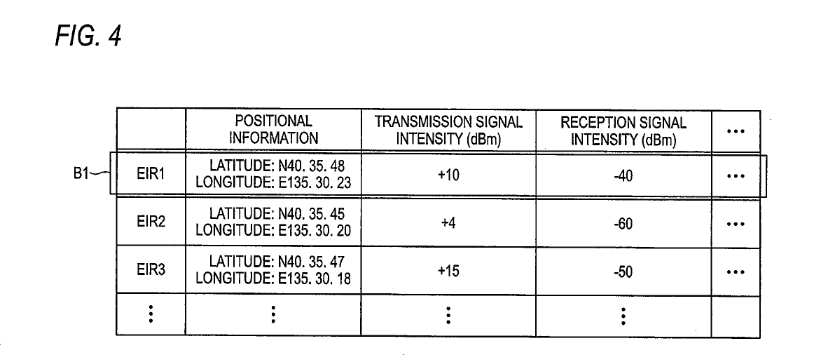

The information extractor 104 extracts Bluetooth address information, positional information, etc. that are contained in each EIR that is input from the communication controller 103. The information extractor 104 generates an information table in which the extracted pieces of positional information etc. are correlated with the respective reception signal level values received from the signal level detector 102. The information extractor 104 updates the information time every time it receives an EIR. When receiving a notice to the effect that the prescribed time T has elapsed, the information extractor 104 supplies the information table to the position determining module 105. The information table will be described later with reference to FIG. 4.

The position determining module 105 performs position determination processing for determining the position of the communication apparatus 100 based on the information table received from the information extractor 104. In the position determination processing, if an EIR was received from only one external apparatus, the position determining module 105 employs, as a position of the communication apparatus 100, the position indicated by the positional information that was extracted from the received EIR. If EIRs were received from plural external apparatus within the prescribed time T from the transmission of inquiry signal, the position determining module 105 determines the position of the communication apparatus 100 based on the plural pieces of positional information that were extracted from the received EIRs. The position determining module 105 supplies positional information indicating the determined position of the communication apparatus 100 to the memory 107 and the video processor 108.

Among methods of position determination which is performed by the position determining module 105 are a method of calculating an average of plural positions and employing it as a position of the communication apparatus 100 and a method of selecting positional information based on EIR transmission signal level values and EIR reception signal level values. The details of the position determination processing as well as the details of the information table will be described later with reference to FIG. 4.

The user interface 106 receives an operation command input by the user. An example user operation command is a user operation command that is made through a position selection screen which is displayed in the position determination processing, which will be described later with reference to FIG. 4.

The memory 107 serves as a storage medium for storing positional information that is supplied from the position determining module 105. Example storage media are a hard disk drive, a memory, and an optical disc. The memory 107 may output stored positional information to the video processor 108. The memory 107 may be stored with map images etc. and output positional information and a map image to the video processor 108. Where the communication apparatus 100 is a digital camera, the memory 107 may store positional information as part of Exif data of an image taken by itself.

The video processor 108 generates a positional information display screen for display of the position of the communication apparatus 100 based on the positional information received from the position determining module 105 or the memory 107. The positional information display screen may be a screen in which the positional information is displayed in the form of a latitude and a longitude, an address, or the like or a screen in which a map image including the position of the communication apparatus 100 and its neighborhood is displayed based on the positional information and a map image that is input from the memory 107.

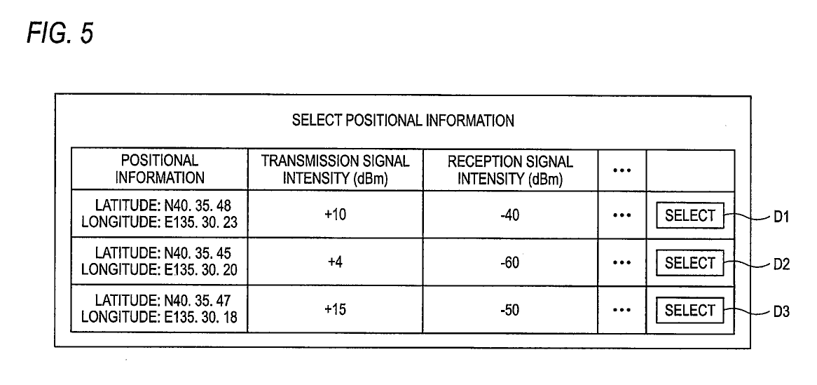

When the communication apparatus 100 has received EIRs from plural external apparatus, the video processor 108 may display a position selection screen for allowing the user to select, as a position of the communication apparatus 100, one of the positions indicated by the pieces of positional information of the plural external apparatus. The pieces of positional information etc. of the plural external apparatus contained in the received EIRs are displayed in the position selection screen to allow the user to select one of the pieces of positional information. The details of the position selection screen will be described later with reference to FIG. 5.

The video processor 108 supplies a signal of the generated positional information display screen or position selection screen to the display device 109, and the display device 109 displays the received screen.

Next, the communication apparatus 200 will be described. The communication apparatus 200 is equipped with a positional information acquiring section 201, a communication controller 202, a communication module 203, etc.

The positional information acquiring section 201 acquires positional information using the GPS, a position determining system using cell phone base stations, or a like system. And the positional information acquiring section 201 supplies the acquired positional information to the communication controller 202. The positional information acquiring section 201 acquires positional information every 10 seconds, for example, and supplies the acquired positional information to the communication controller 202.

The positional information acquiring section 201 need not always be such as to use a position determining system. For example, where the communication apparatus 200 is fixed at a particular location, the positional information acquiring section 201 may such as to acquire positional information that, for example, is input by the user.

The communication controller 202 controls reception of inquiry signal and transmission of an EIR. When receiving inquiry signal from the communication module 203, the communication controller 202 generates an EIR and supplies it to the communication module 203. The communication controller 202 generates an EIR which contains a Bluetooth address of the communication apparatus 200, positional information which is received from the positional information acquiring section 201, and transmission signal level at which the EIR is sent. The EIR will be described later with reference to FIG. 3.

The communication controller 202 may be provided with a storage area for buffering positional information that is input from the positional information acquiring section 201. In this case, the buffered positional information can be updated every time new positional information is input from the positional information acquiring section 201. The communication controller 202 generates an EIR which contains the buffered positional information.

The communication module 203 receives inquiry signal and transmits an EIR. When receiving inquiry signal, the communication module 203 supplies it to the communication controller 202. When receiving an EIR from the communication controller 202, the communication module 203 sends it to the communication apparatus 100. After sending the EIR to the communication apparatus 100, the communication module 203 establishes a communication connection to the communication apparatus 100 by performing authentication processing on a connection request signal that is transmitted from the communication apparatus 100 and contains the Bluetooth address of the communication apparatus 200 and other processing.

Next, the EIR which is sent from the communication apparatus 200 will be described with reference to FIG. 3, which shows an EIR data structure. The EIR is information which is sent in responding to inquiry signal which is a search signal for searching for Bluetooth-compatible apparatus. The EIR can contain, in addition to an apparatus Bluetooth address A1 etc. which are contained in an ordinary inquiry signal response, various kinds of information such as transmission signal level A2, an apparatus vender name (not shown), and an apparatus product name (not shown). The transmission signal level is signal level at which the communication apparatus 200 sends the EIR. In the embodiment, apparatus positional information A3 is contained in the EIR as additional data. Example forms of the positional information A3 are a latitude/longitude combination and an address. The positional information A3 may contain such information as an altitude in addition to a latitude/longitude combination, an address, or the like.

FIG. 4 shows an example of the information table which the information extractor 104 updates when it receives EIR data from the communication controller 103. In the information table, the positional information, the transmission signal level, etc. that are contained in each EIR supplied to the information extractor 104 and reception signal level detected by the signal level detector 202 are correlated with the designation of the EIR. The information table may be such that the vender name, the product name, the apparatus type, and other information contained in each EIR supplied to the information extractor 104 are also correlated with the designation of the EIR. If the communication apparatus 100 has received an EIR which contains positional information indicating a latitude N 40.35.48 and a longitude E 135.30.23 and transmission signal level +10 dBm and the signal level detector 102 has detected EIR reception signal level −40 dBm, the information extractor 104 updates the information table so that information B1 is added (see FIG. 4). The information extractor 104 updates the information table every time it receives a new EIR.

When EIRs have been received from plural external apparatus, the position determining module 105 performs position determination processing for determining the position of the communication apparatus 100 based on the information table. One method of the position determination processing is to use reception signal level values contained in the information table.

In this method, the position determining module 105 selects, as positional information of the communication apparatus 100, the positional information that is contained in an EIR that was received at highest reception signal level among the plural positional information. For example, in the example of FIG. 4, since an EIR1 has highest reception signal level, the position determining module 105 selects, as positional information of the communication apparatus 100, the positional information that is contained in the EIR1. Where EIR transmission signal level values are approximately the same, the EIR reception signal level is higher when the external apparatus is closer to the communication apparatus 100. Therefore, the positional information of an external apparatus that is closer to the communication apparatus 100 can be selected by selecting the positional information that is contained in an EIR having higher reception signal level.

Another method is possible in which attenuation amounts of EIR signal level are calculated based on reception signal level values and transmission signal level values that are contained in the information table and the positional information that is extracted from an EIR that is lowest in the degree of signal level attenuation is selected. An attenuation amount of signal level is calculated according to the following equation:

(Attenuation amount)=(Transmission signal level)−(Reception Signal Level)

For example, for the EIR1, EIR2, and EIR3 shown in FIG. 4, attenuation amounts are calculated as follows according to this equation:

+10−(−40)=50 dBm EIR1

+4−(−60)=64 dBm EIR2

+15−(−50)=65 dBm EIR3

Since the attenuation amount of the EIR1 is smallest, the position determining module 105 employs, as a position of the communication apparatus 100, the positional information that was extracted from the EIR1.

In this manner, even in the case where EIRs containing different transmission signal level values are received from plural external apparatus, the position indicated by the positional information of an external apparatus that is closest to the communication apparatus 100 can be selected as a position of the communication apparatus 100 based on EIR signal level attenuation amounts.

Furthermore, in determining the position of the communication apparatus 100, the position determining module 105 may calculate a position based on plural pieces of positional information. For example, the position determining module 105 calculates an average of plural positions and employs it as a position of the communication apparatus 100.

Still further, when EIRs have been received from plural external apparatus, the position determining module 105 may determine the position of the communication apparatus 100 based on a operation command of the user. More specifically, the position determining module 105 supplies the video processor 108 with an information table that has been generated based on plural EIRs. The video processor 108 generates, based on the received information table, a position selection screen that allows the user to select one of plural pieces of positional information, and the display device 109 displays the position selection screen.

FIG. 5 shows an example position selection screen which is generated by the video processor 108. This position selection screen is generated based on the information table received from the position determining module 105 so as to contain sets of positional information and transmission signal level, reception signal level, and other information that correspond to the positional information. The position selection screen may also contain an apparatus vender name, an apparatus product name, and other information in such a manner that they are correlated with each piece of positional information. The position selection screen also contains selection buttons D1, D2, and D3 that allow the user to select the position indicated by one of the plural pieces of positional information as a position of the communication apparatus 100. When the user interface 106 receives a manipulation on the selection button D1, D2, or D3, the position determining module 105 employs, as a position of the communication apparatus 100, the position indicated by the positional information that has been selected by the user operation command.

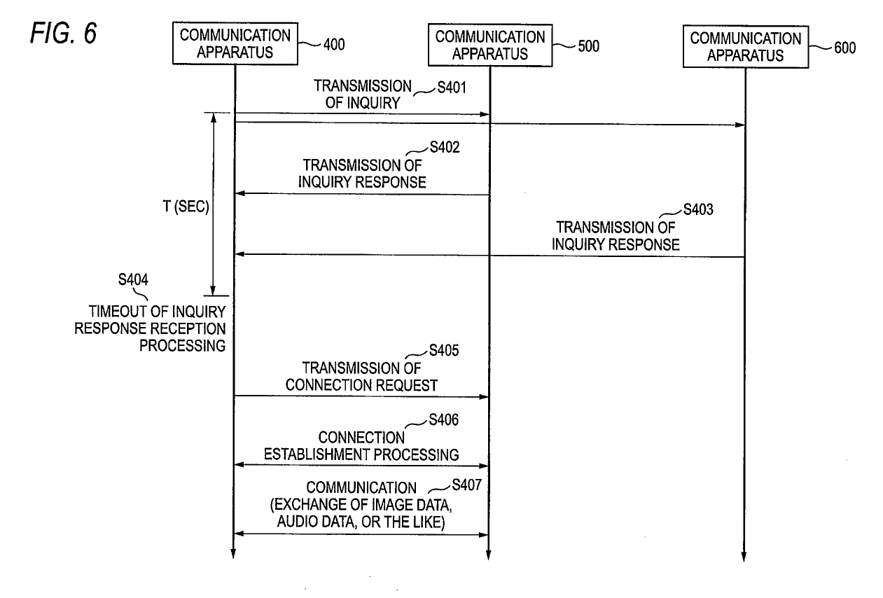

Next, an operation sequence of a communication system which performs an ordinary Bluetooth communication will be described with reference to FIG. 6. This communication system is provided with communication apparatus 400, 500, and 600 etc. Each of the communication apparatus 400, 500, and 600 is equipped with a module which performs a Bluetooth communication.

First, at step S401, the communication apparatus 400 sends inquiry signal to external apparatus to search for external apparatus capable of wireless communication according to the Bluetooth standard and to acquire their Bluetooth addresses. The communication apparatus 400 sends inquiry signal to a large number of unspecified external apparatus rather than particular external apparatus. At steps S402 and S403, when receiving the inquiry signal, the communication apparatus 500 and 600 send back inquiry signal responses which are response signals to the inquiry signal, respectively. The inquiry signal responses which are sent from the communication apparatus 500 and 600 contain their respective Bluetooth addresses.

At step S404, the communication apparatus causes timeout of inquiry signal response reception processing if a time T (sec) has elapsed from the transmission of the inquiry signal at step S401. The time T is a preset timeout period of the inquiry signal response reception processing. The communication apparatus 400 does not process an inquiry signal response that is received after a timeout.

At step S405, the communication apparatus 400 employs, as a connection destination, one of the Bluetooth addresses contained in received inquiry signal responses and sends a connection request that contains the Bluetooth address as the connection destination. If the Bluetooth address that has been employed as the connection destination is the Bluetooth address of the communication apparatus 500, for example, at step S406 the communication apparatus 400 and 500 start connection establishment processing. In the connection establishment processing, the communication apparatus 400 and 500 perform verification of an authentication key and other processing. If the connection establishment processing is completed, at step S407 the communication apparatus 400 and 500 exchange image data, audio data, or the like by performing a communication.

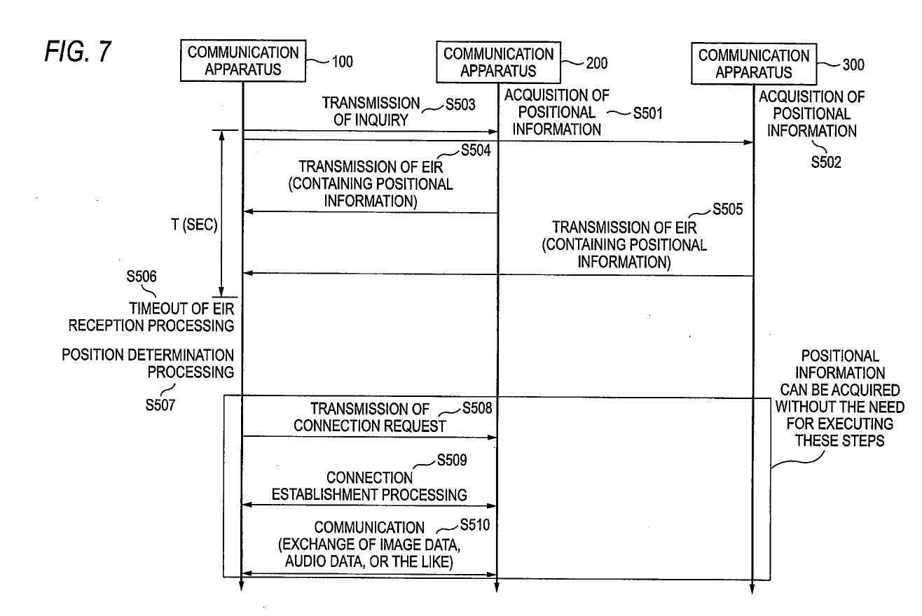

Next, an operation sequence of a communication system according to the embodiment will be described with reference to FIG. 7. Whereas in the operation of FIG. 6 data is transferred after establishment of a connection, in the operation of FIG. 7 positional information can be incorporated in an EIR.

This communication system is provided with communication apparatus 100, 200, and 300. It is assumed that the communication apparatus 100 and 200 have the same configurations as those described above with reference to FIG. 2 and the communication apparatus 300 has the same configuration as the communication apparatus 200.

At step S501 and S502, the communication apparatus 200 and 300 acquire positional information. At step S503, the communication apparatus 100 sends inquiry signal. When receiving the inquiry signal, at step S504 and S505 the communication apparatus 200 and 300 send, to the communication apparatus 100, as response signals, EIRs containing their respective pieces of positional information and pieces of other information. At step S506, the communication apparatus 100 causes timeout of EIR reception processing when the time T (sec) has elapsed from the transmission of the inquiry signal.

Whereas the transmission of inquiry signal, the transmission of an EIR in response to the inquiry signal, etc. correspond to the transmission of inquiry signal, the transmission of an inquiry signal response, etc. that are performed in the communication system of FIG. 6 which performs an ordinary Bluetooth communication, the communication system of FIG. 7 according to the embodiment is different from the communication system of FIG. 6 in that each response signal (EIR) to the inquiry signal contains positional information.

When a timeout has occurred in the EIR reception processing, at step S507 the communication apparatus 100 performs position determination processing. In the position determination processing, as described above, the communication apparatus 100 determines its position based on the pieces of positional information extracted from the received EIRs.

Then, steps S508-510 can be performed. That is, at step S508, the communication apparatus 100 sends, to the communication apparatus 200, for example, having the Bluetooth address that was contained in one of the received EIRs, a connection request containing that Bluetooth address. At step S509, the communication apparatus 100 and 200 perform connection establishment processing. After establishment of a connection, at step S510 the communication apparatus 100 and 200 performs a communication. In the embodiment, pieces of positional information can be acquired without the need for executing step S508-510.

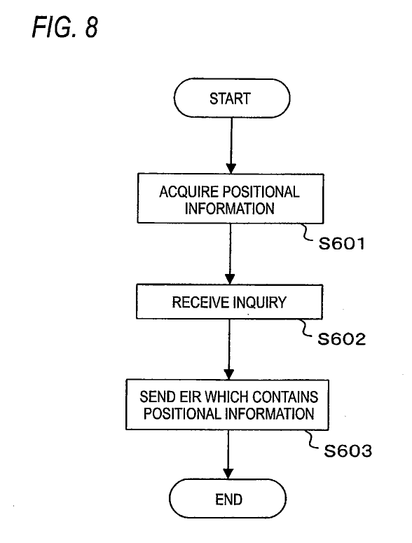

Next, an operation that the communication apparatus 200 sends an EIR containing positional information will be described with reference to FIG. 8.

First, at step S601, the positional information acquiring section 201 acquires positional information. This can be done by using the GPS, a position determining system using cell phone base stations, or a like system. Where the communication apparatus 200 is fixed at a particular location, the positional information acquiring section 201 may acquire positional information that is manipulation-input by the user. The positional information acquiring section 201 supplies the acquired positional information to the communication controller 202.

When the communication module 203 receives inquiry signal at step S602, at step S603 the communication controller 202 generates an EIR containing the positional information and the communication module 203 sends out the EIR.

With the above operation, the communication apparatus may send positional information easily without the need for establishing a communication connection to the communication apparatus 100. Since it is not necessary to establish a communication connection, the time that is taken by the positional information transmission processing can be shortened. Since the communication apparatus 200 sends an EIR containing positional information in response to inquiry signal that is transmitted from the communication apparatus 100, the communication apparatus may send positional information when the communication apparatus requires the positional information.

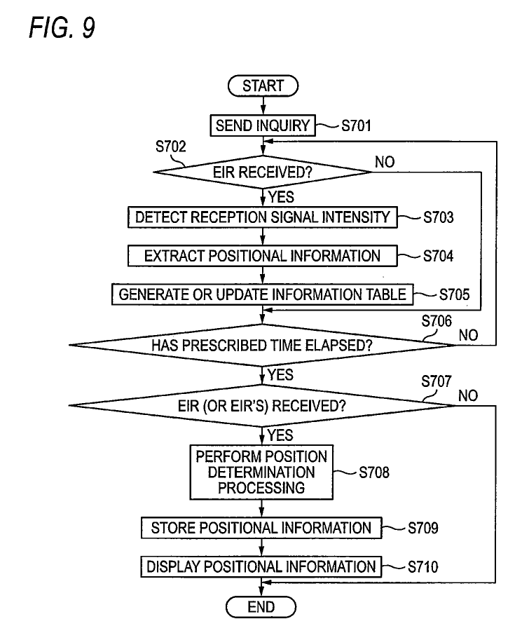

Next, an operation that the communication apparatus 100 determines its position will be described with reference to FIG. 9.

First, at step S701, the communication module 101 sends inquiry signal to unspecified external apparatus. At step S702, when the communication module 101 receives an EIR as a response to the inquiry signal at step S702, at step S703 the signal level detector 102 detects reception signal level of the EIR and supplies information indicating the reception signal level to the information extractor 104. At step S104, the information extractor 104 extracts the positional information etc. that are contained in the EIR. At step S705, the information extractor 104 generates (or updates) an information table using the extracted positional information, the information indicating the reception signal level supplied from the signal level detector 102, and other information.

At step S706, the communication controller 103 determines whether or not the time T (sec) has elapsed from the transmission of the inquiry signal. If the time T has not elapsed yet (S706: no), the communication apparatus 100 executes steps S702-S706 again. In this manner, reception signal level is detected, positional information is extracted, and the information table is updated every time an EIR is received.

If the time T has elapsed from the transmission of the inquiry signal (S706: yes), at step S707 the communication controller 103 determines whether or not an EIR(s) has been received. If an EIR(s) has not been received (S707: no), this operation is finished. If an EIR(s) has been received (S707: yes), the communication controller 103 supplies the information extractor 104 with a notice to the effect that the time T has elapsed. When receiving this notice, at step S708 the information extractor 104 supplies the generated information table to the position determining module 105. And the position determining module 105 performs the above-described position determination processing based on the received information table and supplies positional information indicating a determined position of the communication apparatus 100 to the memory 107.

At step S709, the memory 107 (memory, hard disk drive, or the like) stores the positional information received from the position determining module 105 (permanent or temporary storage) and supplies the positional information to the video processor 108. At step S710, the video processor 108 generates a positional information display screen for display of the positional information indicating the determined position of the communication apparatus 100 and supplies a signal of this screen to the display device 109.

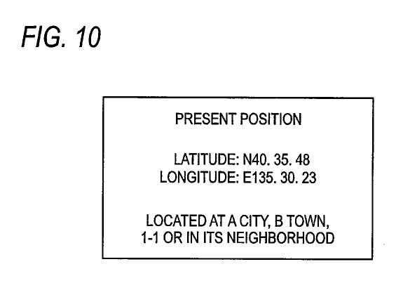

FIG. 10 shows an example positional information display screen which is displayed by the display device 109. In the screen of FIG. 10, positional information is displayed in the form of a latitude/longitude combination and an address. A map image including the position of the communication apparatus 100 and its neighborhood may be displayed in the positional information display screen. Where the communication apparatus 100 is a digital camera, an image taken by itself may be displayed so as to be correlated with the positional information or the positional information may be stored as part of Exif data of an image taken by itself.

With the above operation, the communication apparatus 100 can easily acquire pieces of positional information from unspecified external apparatus without the need for determining communication destinations, establishing communication connections, and performing other processing. Since the communication apparatus 100 is capable of acquiring pieces of positional information without establishing communication connections or performing other processing, the time taken to acquire pieces of positional information can be shortened. The communication apparatus 100 is capable of acquiring pieces of positional information with proper timing by sending inquiry signal when it needs them. Furthermore, when receiving EIRs containing respective pieces of positional information from plural external apparatus, the communication apparatus 100 can select positional information indicating a position that is determined closest to the communication apparatus 100 based on sets of reception signal level, transmission signal level, and other information.

### Second Embodiment

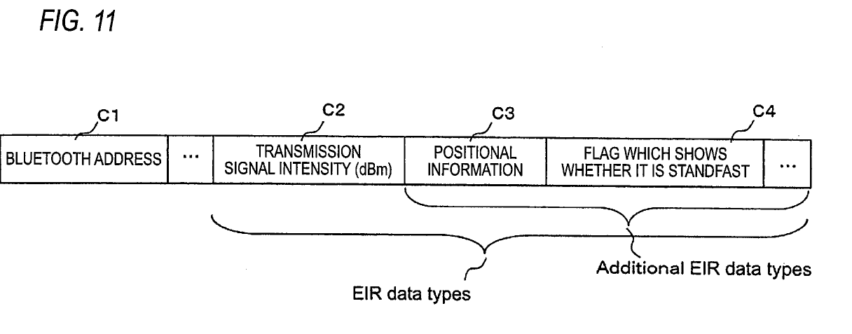

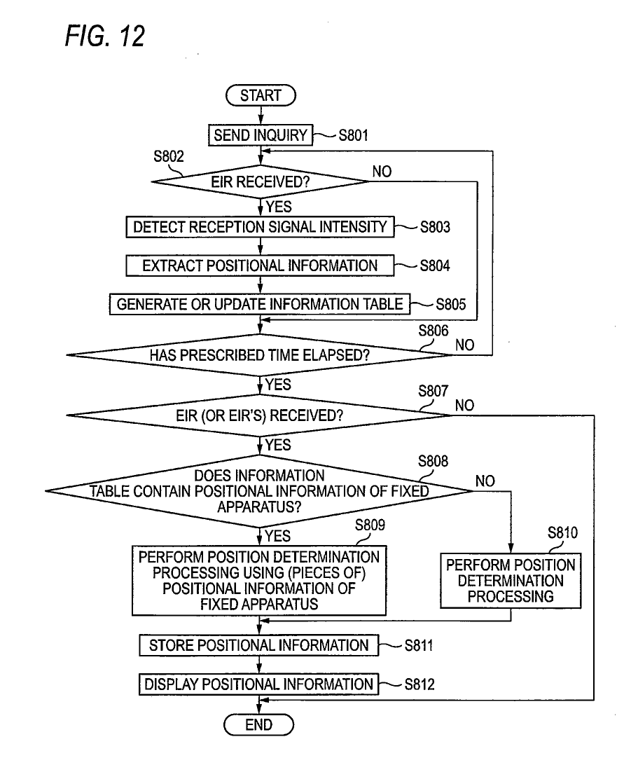

Next, a second embodiment of the invention will be described with reference to FIGS. 11 and 12. In this embodiment, the communication apparatus may send an EIR which contains, in addition to transmission signal level and positional information, information indicating whether or not the positional information is of an apparatus that is fixed at a particular location. When receiving plural EIRs, the communication apparatus 100 preferentially selects (pieces of) positional information of a fixed apparatus among the pieces of positional information contained in the received EIRs. The term “apparatus fixed at a particular location” means an apparatus that is installed at such a location as a sightseeing spot or a location (e.g., the inside of a building or underground) where a position determination module such as the GPS cannot be used and that can send an EIR in response to inquiry signal, or a like apparatus. Since such an apparatus is fixed and does not vary in position, it need not be equipped with a position determination module. Such an apparatus may acquire positional information by, for example, causing the user to manipulation-input positional information. In this manner, the communication apparatus 100 can preferentially select correct positional information at a location where a position determination module cannot be used or a famous location.

The configurations of the apparatus will not be described in detail because they are substantially the same as in the first embodiment.

FIG. 11 shows an example structure of data that are contained in an EIR which is sent by the communication apparatus 200 in the embodiment. The EIR contains a Bluetooth address C1, transmission signal level C2, positional information C3, and a flag C4 indicating whether the position is fixed or not.

Next, an operation of the communication apparatus 100 according to the embodiment will be described with reference to FIG. 12. Steps S801-S803, steps S806 and S807, and steps S811 and S812 in FIG. 12 are the same as steps S701-S703, steps S706 and S707, and steps S709 and S710 in FIG. 9, respectively. Steps that are different than in the operation of FIG. 9 will mainly be described below.

After the communication apparatus 100 sent inquiry signal and detected reception signal level of a received EIR at steps S801-S803, at step S804 the information extractor 104 of the communication module 100 extracts, from the EIR, the Bluetooth address, positional information, transmission signal level, information indicating whether or not the position is fixed, and other information. At step S805, the information extractor 104 generates (or updates) an information table based on the pieces of information extracted from the EIR.

If the time T (sec) has elapsed from the transmission of the inquiry signal (S806: yes), at step S807 the communication controller 103 determines whether or not an EIR(s) has been received. If an EIR(s) has not been received (S807: no), this operation is finished. If an EIR(s) has been received (S807: yes), the information extractor 104 receives a notice to the effect that the time T has elapsed from the communication controller 103. At step S808, the information extractor 104 supplies the information table generated at step S805 to the position determining module 105. And the position determining module 105 determines whether or not the information table received from the information extractor 104 contains positional information of a fixed apparatus. If the information table contains positional information of a fixed apparatus (S808: yes), at step S809 the position determining module 105 performs the above-described position determination processing using the (pieces of) positional information of the fixed apparatus and supplies positional information indicating a determined position of the communication apparatus 100 to the memory 107. If the information table contains only one piece of positional information indicating a fixed position, the position determining module 105 employs, as a position of the communication apparatus 100, the position indicated by the one piece of positional information and supplies it to the memory 107.

At steps S808 and S809, if at least one EIR contains positional information indicating a fixed position, a position selection screen for selection of one of plural pieces of positional information including (pieces of) positional information of a fixed apparatus and pieces of positional information of non-fixed apparatus may be displayed on the display device 109 so that the position of the communication 100 will be determined based on a user operation command through the position selection screen. The display device 109 displays the position selection screen in such a display form that the user can recognize which of the plural pieces of positional information is positional information of a fixed apparatus.

On the other hand, if the information table does not contain positional information of a fixed apparatus (S808: no), at step S810 the position determining module 105 performs the same position determining processing as performed at step S708 (see FIG. 9) and supplies positional information indicating a determined position of the communication apparatus 100 to the memory 107.

At step S811, the memory 107 stores the positional information received from the position determining module 105 (permanent of temporary storage) and supplies the positional information to the video processor 108. At step S812, the video processor 108 generates a positional information display screen based on the positional information received from the memory 107 and the display device 109 displays the screen generated by the video processor 108. The operation of the communication apparatus 100 is thus completed.

With the above operation, if received EIRs include an EIR(s) transmitted from a fixed apparatus, the communication apparatus 100 can preferentially select the (pieces of) positional information of the fixed apparatus and determine the position of the communication apparatus 100 using that (those pieces of) positional information. Therefore, if an apparatus capable of sending an EIR in response to inquiry signal is installed at such a particular location as a sightseeing spot, the communication apparatus 100 is capable of acquiring correct positional information of the particular location.

Although the embodiments according to the present invention have been described above, the present invention is not limited to the above-mentioned embodiments but can be variously modified. Constituent components disclosed in the aforementioned embodiments may be combined suitably to form various modifications. For example, some of all constituent components disclosed in the embodiments may be removed or may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication apparatus comprising:
a transmitter configured to transmit to an external apparatus a search signal for requesting the external apparatus to transmit an address that is uniquely assigned to the external apparatus;
a receiver configured to receive a response signal being transmitted from the external apparatus in response to the search signal, the response signal containing positional information and the address of the external apparatus; and
an extractor configured to extract the positional information from the response signal received by the receiver.

2. The apparatus of claim 1 further comprising:
a communication controller configured to transmit a connection request containing the address that is contained in the received response signal to the external apparatus having the address and to establish a communication connection to the external apparatus.

3. The apparatus of claim 1,
wherein the receiver is configured to receive from the external apparatus the response signal that contains the positional information, the address of the external apparatus, and information indicating whether the positional information indicates a fixed position,
wherein the extractor is configured to extract the information indicating whether the positional information indicates a fixed position from the response signal, and
wherein the communication apparatus further comprises:
a selector configured to select, when a plurality of the response signals are received by the receiver, a piece of positional information indicating the fixed position from a plurality of the positional information extracted from the response signals based on the information indicating whether the positional information is the fixed position.

4. The apparatus of claim 1 further comprising:
a determination module configured to employ, when the receiver receives a plurality of the response signals, as positional information of the communication apparatus, secondary positional information that does not coincide with any of the positional information extracted from the response signals.

5. The apparatus of claim 4,
wherein the secondary positional information is a positional information indicating a coordinate obtained by averaging a plurality of coordinates included in the plurality of positional information extracted from the plurality of response signals

6. The apparatus of claim 1 further comprising:
a selector configured to select, when a plurality of the response signals are received by the receiver, a piece of positional information from a plurality of the positional information extracted from the response signals.

7. The apparatus of claim 6 further comprising:
a detector configured to detect reception signal level of the response signal received by the receiver,
wherein the selector is configured to select one piece of the positional information that is extracted from a response signal having highest reception signal level among the plurality of pieces of positional information extracted from the plurality of the response signals received by the receiver.

8. The apparatus of claim 6 further comprising:
a detector configured to detect reception signal level of the response signal received by the receiver,
wherein the receiver is configured to receive, from each of a plurality of the external apparatuses, a response signal that further contains information indicating transmission signal level at which the response signal is sent by the respective external apparatuses,
wherein the extractor is configured to extract the information indicating the transmission signal level from each of the response signals received by the receiver, and
wherein the selector is configured to select one piece of positional information that is extracted from a response signal having lowest signal level attenuation that is calculated based on the transmission signal level and the reception signal level among the plurality of pieces of positional information extracted from the plurality of the response signals received by the receiver.

9. The apparatus of claim 6 further comprising:
a display device configured to display, when the receiver receives a plurality of the response signals, a screen for selecting one of the plural pieces of positional information extracted from the response signals.

10. A communication apparatus comprising:
a receiver configured to receive a search signal transmitted from an external apparatus for requesting to transmit an address that is uniquely assigned to the communication apparatus; and
a transmitter configured to transmit a response signal containing positional information and the address of the communication apparatus to the external apparatus when the search signal is received by the receiver from the external apparatus.

11. The apparatus of claim 10 further comprising:
a communication controller configured to establish a communication connection to the external apparatus when a connection request is received from the external apparatus, the connection request containing the same address as the address contained in the response signal after the transmitter transmits the response signal to the external apparatus.

12. The apparatus of claim 10 further comprising:
a positional information acquiring module configured to acquire positional information,
wherein the transmitter is configured to transmit the response signal further containing the positional information acquired by the positional information acquiring module.

13. The apparatus of claim 10,
wherein the transmitter is configured to transmit the response signal further containing transmission signal level at which the response signal is transmitted.

14. The apparatus of claim 10,
wherein the transmitter is configured to transmit the response signal further containing information indicating whether the positional information is positional information of a fixed position.

15. A positional information communicating method in a system including a first communication apparatus and a second communication apparatus, the method comprising:
transmitting from the first communication apparatus a search signal for requesting transmission of an address that is uniquely assigned to an apparatus that received the search signal;
receiving the search signal by the second communication apparatus;
transmitting a response signal by the second communication apparatus to the first communication apparatus in response to the search signal, the response signal containing positional information and an address of the second communication apparatus; and
receiving the response signal by the first apparatus.
